(19) United States
(12) Patent Application Publication
(10) Pub. No.: US 2003/0046458 A1
(43) Pub. Date: Mar. 6, 2003

(54) Data transfer equipment and aligner included in data transfer equipment

(76) Inventor: Kenta Morishima, Kokubunji (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/175,320

(22) Filed: Jun. 20, 2002

(30) Foreign Application Priority Data
Aug. 28, 2001 (JP) 2001-258343

(51) Int. Cl. G06F 13/28

(52) U.S. Cl. 710/22

(57) ABSTRACT

The present invention provides a communication controller of a higher rate, which enables a data transfer at the maximum bus width if an inconsistency of data alignment is present, when DMA transferring a communication frame with its header and payload data into respective exclusive memory space. To achieve this, an aligner ALIGN is provided on the bus between the DMA controller and the main memory MAINMEM. The aligner ALIGN is comprised of a selector RXSEL for selecting 32 bits of data from the register RX_REG for storing data of previous writing and from the DMAC data bus to output data to the bus of main memory MAINMEM, a selector TXSEL for selecting 32 bits of data from the register TXREG for storing data of previous reading and from the CPU data bus to output data to the DMA bus, an inconsistent alignment detector circuit ALGN_CHK for detecting the inconsistency of alignment to determine the signal lines to be selected by the selector, and an address generator ADR_CNV for generating address signals for the CPU from the address signals of the DMAC. Since transfer at the maximum bus width is enabled even when the inconsistency of alignment is present, transfer may be performed in the time and number half of the conventional controller.

### FIELD OF THE INVENTION

The present invention relates to data transfer equipment, and more particularly relates to data transfer equipment which have an aligner to allow absorbing inconsistency of alignment that may occur during data transfer.

### BACKGROUND OF THE INVENTION

There have been known data transfer equipment having a direct memory access controller (DMAC) for extracting the header and data parts of a frame received by a communication device through a FIFO buffer in order to allow writing thus separated header and data automatically into the receiving header memorizing area and receiving data memorizing area, respectively, reserved in a storage area. Such equipment has been developed for the purpose of remedying the load of processing in the transaction and/or application layer, and also has had a means for connecting a set of head information and data information automatically read out from the transmitting header memorizing area and transmitting data memorizing area respectively, at the time of transmission in order to alleviate the processing load in the upper layers. This sort of technique is disclosed, for example in the Japanese Published Patent Laid-Open No. 2000-134242 and Hei-6-244902.

In accordance with the Prior Art technique, however, if the size of header part is not a multiple of the data bus width, there will occur a inconsistency of data alignment during data part transfer, which may result in the transfer restricted to less than the maximum bus width, hence result in some degradation of efficiency. This disadvantage will be described below.

The width of internal bus of a system may be sometimes expanded for aiming at a faster data transfer within the system, as the amount of processing data handled by the system increases and as the transfer rate increases. With an expanded bus width, the inconsistency of the header length of a communication frame with the bus width will be elicited.

Now referring to the accompanying drawings, FIG. 3 shows a frame configuration on an Ethernet network, communicated between a DMA controller and a core of the media access controller (MAC) layer of the Ethernet. A frame is constituted of a header of 14 bytes containing the destination MAC address ‘DEST_ADR’, the source MAC address ‘SRC_ADR’, and the length of frame, and a data part ‘DATA’.

Now referring to FIG. 2, a preamble ‘PRE ’ a start frame delimiter ‘SFD’, a frame check sequence ‘FCS’, will be added in the MAC layer core as shown, and the frame will be shaped conforming to the media independent interface ‘MII’ prior to the transmission to the chip in the physical layer. Since the header length of a header part of a frame is 14 bytes, and if the bus width is 16 bits, there will be no problem because the header length is just seven times of the bus width. If the bus width becomes 32 bits, then the header length will be 3.5 times of the bus width, causing an inconsistent alignment when extracting and writing data part into the storage area. In this context a solution is to restrict the transfer width to 16 bits.

Now referring to FIG. 4, a FIFO with the data width of 32 bits, data buffer ‘DAT_BUF’ for storing the data part and a header buffer ‘HED_BUF’ for storing the header section are interconnected each other with a bus of 32 bits. When attempting to transfer the leading 4 bytes of data part ‘DAT ’ from a frame received into the FIFO and constituted of a header part ‘HED’ and a data part ‘DAT’ into a data buffer DAT_BUF, the very leading two bytes and the following two bytes are to be separately transferred because the FIFO may not be able to have access to those four bytes at once.

In case of transmission, similarly, when transferring data part followed by a header transferred from the header buffer ‘HED_BUF’ to the FIFO, four bytes of data from the data buffer ‘DAT_BUF’ are to be transferred for each 2 bytes since the four bytes of data from the data buffer ‘DAT_BUF’ are not allowed to be written into the header section ‘HED’ in the FIFO. This means that the transfer time needs twice when compared to the transfer at the maximum bus width.

It is an object of the present invention to overcome the above problems and to provide a mechanism for absorbing the inconsistent alignment to enable data transfer at the maximum bus width.

### SUMMARY OF THE INVENTION

In order to achieve the above mentioned object and in accordance with the purpose of the invention, as embodied and broadly described herein, the present invention provides the following devices and the like.

The present invention provides data transfer equipment, comprising: a CPU for data communication controller; a storage area for storing a communication frame transmitted and received through a bus to which the CPU is connected; a controller for controlling the transfer of the communication frame without intervention of the CPU; a memory between the controller and a communication device including physical layer and logical layer; wherein a transmitting header memorizing area, transmitting data memorizing area, receiving header memorizing area, receiving data memorizing area are provided in the storage area in order to divide transmitting frame and receiving frame into header and data part thereof, respectively, for storing the header and data part; wherein the controller contains an alignment controller for controlling the alignment of the transmitting and receiving frames each constituted of the header part and the data part with the addresses provided in the each memorizing areas in the storage area; wherein the controller extracts the header part and the data part from the receiving frame stored temporarily in the memory so as to separately store the header of the receiving frame into the receiving header memorizing area and the data part of the receiving frame into the receiving data memorizing area, without the needs of intervention by the CPU, by means of data transfer through the alignment controller; wherein the controller further instructs the alignment controller to transfer therethrough the header of the transmitting frame from the transmitting header memorizing area to the memory, and then instructs the alignment controller to transfer therethrough the data part of the transmitting frame from the transmitting data memorizing area to the memory in order to reconstruct a transmitting frame from within the memory.

The present invention further provides data transfer equipment, comprising: a CPU for data communication controller; a storage area for storing a communication frame transmitted and received through a bus to which the CPU is connected; a controller for controlling the transfer of the communication frame without intervention of the CPU; a memory disposed between the controller and a communication device including a physical layer and a logical layer; and an aligner interposed between a bus for the connection to the storage area and a bus for the connection to the controller, wherein the aligner comprises an address generator for generating addresses, a detector for detecting any inconsistency of alignment, a register for storing data, and a selector for selecting the stored data; wherein the aligner is capable of detecting the inconsistency of the alignment at the detector when there is an inconsistent alignment of data transferred from the storage area with the address output from the controller and presented on the bus for the connection to the controller; wherein the aligner is capable of dividing the data transferred to the bus and the address output into a first data corresponding to a first address consistently aligned through the selector, so as to output the first data to the bus for the connection to the storage area.

Furthermore, the present invention provides an aligner, comprising: a detector for detecting any inconsistency in the alignment that is occurred during data transfer; an address generator for generating addresses; a register for storing data input from any external devices; and a selector for selecting the data stored and for processing the data; wherein the aligner uses the detector to enable to detect the inconsistency of alignment for generating address having the alignment adjusted in the address generator and enable to compensate for the inconsistent alignment at the time the inconsistency of alignment has occurred, so as to be capable of transferring data in correspondence with the address adjusted at the maximum width of the system bus.

The above and further objects and novel features of the present invention will more fully appear from following detailed description when the same is read in connection with the accompanying drawings. It is to be expressly understood, however, the drawings are for the purpose of illustration only and not intended as a definition of the limits of the present invention.

### BRIEF DESCRIPTION OF THE DRAWINGS

The accompanying drawings, which are incorporated in and constitute a part of this specification illustrate an embodiment of the invention and, together with the description, serve to explain the objects, advantages and principles of the invention. In the drawings,

FIG. 1 is a schematic block diagram of a residential gateway device in accordance with first preferred embodiment of the present invention;

FIG. 2 is a schematic diagram of data format used in an Ethernet packet for communicating to the physical layer via MII;

FIG. 3 is a schematic diagram of data format used in an Ethernet packet to be DMA transferred from the MAC layer to the buffer area;

FIG. 4 is a schematic diagram indicative of occurrence of an inconsistency of alignment of data part;

FIG. 5 is a schematic block diagram of a 32-bit boundary buffering circuit in relation with the present invention;

FIG. 6 is a schematic block diagram of a 64 bit boundary buffering circuit in relation with the present invention;

FIG. 7 is a flow chart indicative of the DMAC operation when receiving a frame in accordance with the first preferred embodiment of the present invention;

FIG. 8 is a flow chart indicative of the DMAC operation when transmitting a frame in accordance with the first preferred embodiment of the present invention;

FIG. 9 is a schematic block diagram depicting the operating status (1) of a boundary buffering circuit when receiving a frame with the header length of 6n (4n+2) in accordance with the present invention;

FIG. 10 is a schematic block diagram depicting the operating status (2) of a boundary buffering circuit when receiving a frame with the header length of 6 (4n+2) in accordance with the present invention;

FIG. 11 is a schematic block diagram depicting the operating status (3) of a boundary buffering circuit when receiving a frame with the header length of 6 (4n+2) in accordance with the present invention;

FIG. 12 is a schematic block diagram depicting the operating status (4) of a boundary buffering circuit when receiving a frame with the header length of 6 (4n+2) in accordance with the present invention;

FIG. 13 is a schematic block diagram depicting the operating status (1) of a boundary buffering circuit when transmitting a frame with the header length of 6 (4n+2) in accordance with the present invention;

FIG. 14 is a schematic block diagram depicting the operating status (2) of a boundary buffering circuit when transmitting a frame with the header length of 6 (4n+2) in accordance with the present invention;

FIG. 15 is a schematic block diagram depicting the operating status (3) of a boundary buffering circuit when transmitting a frame with the header length of 6 (4n+2) in accordance with the present invention;

FIG. 16 is a schematic block diagram depicting the operating status (4) of a boundary buffering circuit when transmitting a frame with the header length of 6 (4n+2) in accordance with the present invention;

FIG. 17 is a schematic block diagram of a residential gateway having an aligner in accordance with second preferred embodiment of the present invention;

FIG. 18 is a schematic block diagram of an aligner in accordance with the present invention;

FIG. 19 is a schematic block diagram of selectors when receiving within the aligner in accordance with the present invention;

FIG. 20 is a schematic block diagram of selectors when transmitting within the aligner in accordance with the present invention;

FIG. 21 is a table indicative of the relationship of values between the data buses and address buses on both sides of the aligner when receiving a frame in accordance with the present invention;

FIG. 22 is a table indicative of the relationship of values between the data buses and address buses on both sides of the aligner when transmitting a frame in accordance with the present invention;

FIG. 23 is a flow chart indicative of the DMAC operation when receiving a frame in accordance with the second preferred embodiment of the present invention;

FIG. 24 is a flow chart indicative of the DMAC operation when transmitting a frame in accordance with the second preferred embodiment of the present invention;

FIG. 25 is a schematic circuit block diagram of DMA transfer from a FIFO at the data bus width, when the FIFO bus width is narrower than the data bus;

FIG. 26 is a schematic circuit block diagram of DMA transfer into a FIFO at the data bus width, when the FIFO bus width is narrower than the data bus;

FIG. 27 is a schematic circuit block diagram of a communication controller, having an aligner connected to each DMAC corresponding to a plurality of communication devices in relation with the present invention;

FIG. 28 is a schematic circuit block diagram of a communication controller, having an aligner provided between a bus to which connected are a variety of communication devices and the storage area, in accordance with the present invention;

FIG. 29 is a schematic circuit block diagram of a communication controller, having an aligner provided between a bus to which connected are a variety of communication devices and the processor, and a bus to which the storage area is connected, in accordance with the present invention; and

FIG. 30 is a schematic block diagram of a VOIP telephone system by means of the first preferred embodiment of the present invention shown in FIG. 1.

### DETAILED DESCRIPTION OF THE PREFERRED EMBODIMENTS

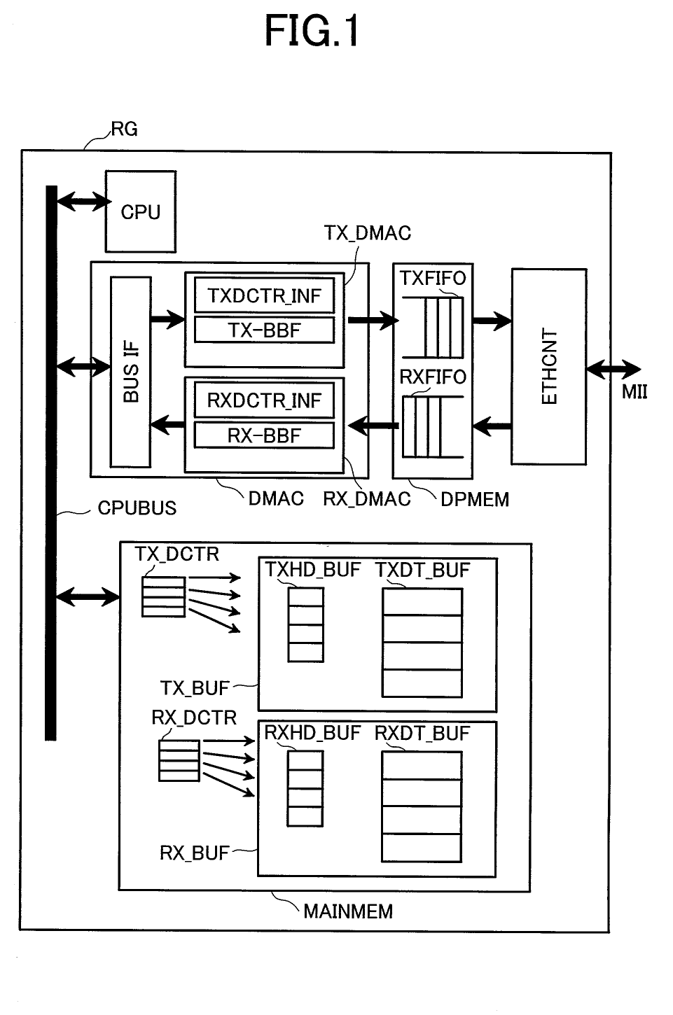

A detailed description of the preferred embodiment embodying the present invention will now be given referring to the accompanying drawings. In the following description, the similar or equivalent members are designated to the identical reference numbers. Now a first preferred embodiment of the present invention will be described in greater details below with reference to the accompanying drawings. Referring to FIG. 1, there is shown a schematic block diagram of the device in accordance with the first embodiment of the present invention. The device, referred to as a Residential Gateway (RG) device, is a communication control equipment and an information processing equipment equipped with an Ethernet controller for the communication interface.

The device has a CPU for controlling the operation of the device and for processing tasks in the upper, application layer. The bus to which the CPU is connected may connect to its main memory MAINMEM and a DMA controller for communication (DMAC). In the main memory MAINMEM there will be created buffer areas for storing transmitting and receiving frames via the Ethernet as well as the descriptors pointing out to the locations. The transmitting buffer descriptor TX_DCTR is a descriptor for pointing to the address and the states of a transmitting header buffer TXHD_BUF for storing a transmitting header, and of a transmitting data buffer TXDT_BUF (or transmitting data memorizing area) for storing a transmitting data. The receiving buffer descriptor RX_DCTR is another descriptor for pointing to the addresses and status of a receiving header buffer area RXHD_BUF, and of a receiving data buffer area RXDT_BUF (or receiving data memorizing area).

The DMAC is connected through a memory such as a dual port memory (DPMEM) comprised of a FIFO to an Ethernet controller ETHCNT of the MAC layer. The DMAC is responsible for the data transfer of the transmitting and receiving frames from and to the main memory MAINMEM. The Ethernet controller ETHCNT is further connected to a physical layer chip via MII (Media Independent Interface).

The dual port memory DPMEM, as FIFO, is provided for mediating the difference in the operating timings of the DMAC and ETHCNT, and is equipped with a transmitting FIFO area TXFIFO, and a receiving FIFO area RXFIFO. The DMAC may have a transmitting DMAC TX_DMAC for controlling the DMA transfer for outbound transmission and a receiving DMAC RX_DMAC for controlling the DMA transfer for inbound reception, as well as the arbitrator BUSIF for arbitrating access to the CPU bus CPUBUS from both DMACs.

The receiving DMAC RX_DMAC may have, in addition to the ordinary DMAC function of DMA transfer by specifying a destination address and a transfer size, a receiving descriptor information circuit RXDCTR_INF for retrieving the receiving descriptor for determining the address in the receiving header buffer and the address in the receiving data buffer, and a boundary buffer circuit RX_BBF (or an alignment controller) for compensating for the inconsistent alignment between the data and address for allowing data transfer in the maximum width of system bus, even if there is an inconsistency of alignment between data and address when outputting or transferring frame data input from the receiving FIFO area RXFIFO into the receiving data buffer RXDT_BUF.

The transmitting DMAC TX_DMAC may have, in addition to the ordinary DMAC function of DMA transfer by specifying a source address and a destination address as well as a transfer size, a transmitting descriptor information circuit TXDCTR_INF for retrieving the transmitting descriptor for determining the address in the transmitting header buffer and the address in the transmitting data buffer, and a transmitting boundary buffer circuit TX_BBF (or an alignment controller) for compensating for the inconsistent alignment between the data and the address for allowing data transfer in the maximum width of system bus, even if there is an inconsistency of alignment between data and address when outputting or transferring an input from the TX_BUF (transmitting header buffer TXHD_BUF and transmitting data buffer TXDT_BUF) into the transmitting FIFO area TXFIFO.

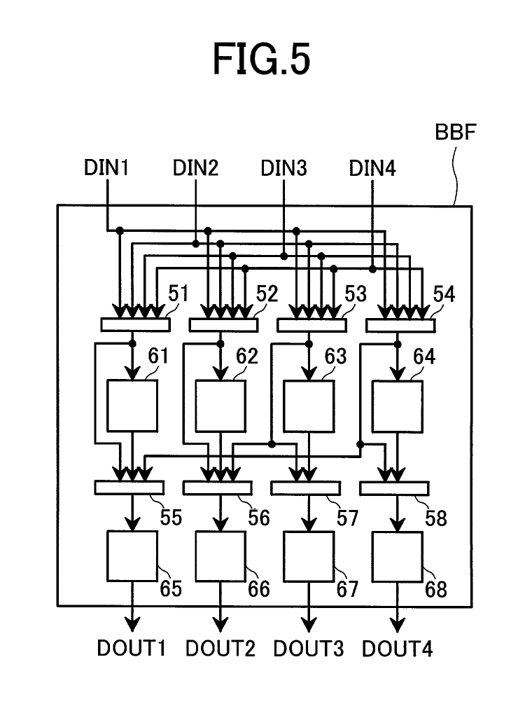

Referring to FIG. 5, there is shown a representative example of a boundary buffering circuit BBF of 32-bit wide, in the DMAC. The transmitting boundary buffer circuit TX_BBF and boundary buffer circuit RX_BBF has an identical configuration, including selectors 51 to 58, and latches 61 to 68. DIN1 to DIN4 are inputs from the receiving FIFO area RXFIFO or transmitting buffer TX_BUF comprised of a transmitting header buffer TXHD_BUF and a transmitting data buffer TXDT_BUF, while DOUT1 to DOUT4 are outputs from the boundary buffering circuit BBF. The DOUTs will be written into the transmitting FIFO area TXFIFO when transmitting a frame, or written into the receiving header buffer RXHD_BUF or the receiving data buffer RXDT_BUF when receiving a frame from the Ethernet controller ETHCNT through receiving FIFO area RXFIFO. Switching selectors may allow the ultimate compensation for the inconsistency of alignment. The circuit may also be extended so as to accommodate to a 64-bit wide system.

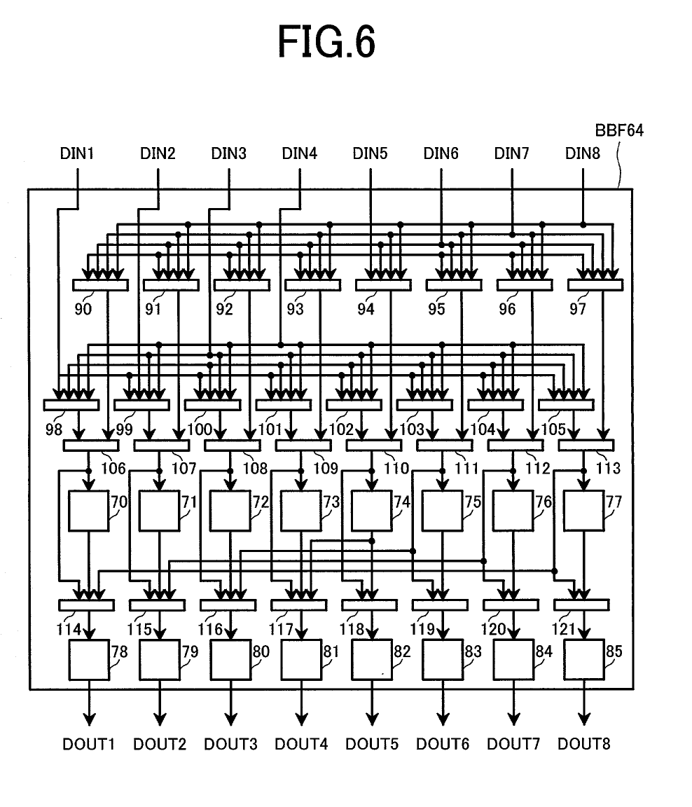

Referring to FIG. 6, there is shown a boundary buffering circuit BBF 64 for a bus of 64-bit wide. One of inputs DIN1 to DIN 8 will be selected by selectors 90 to 113, to input to latches 70 to 77. Two or three inputs to the selectors 114 to 121, which are fed to input of latches 78 to 85, will be supplied from the above mentioned selectors 90 to 113 and latches 70 to 77. The inputs of latches 78 to 85 will become DOUT 1 to 8 in the succeeding cycle. As have been described as above, if the bus width is expanded, multi-bit width input can be achieved by the combination of two-stage latches, multi-byte input selectors compatible with the bus width of the input stage, two-or three-input selectors and latches in the back end.

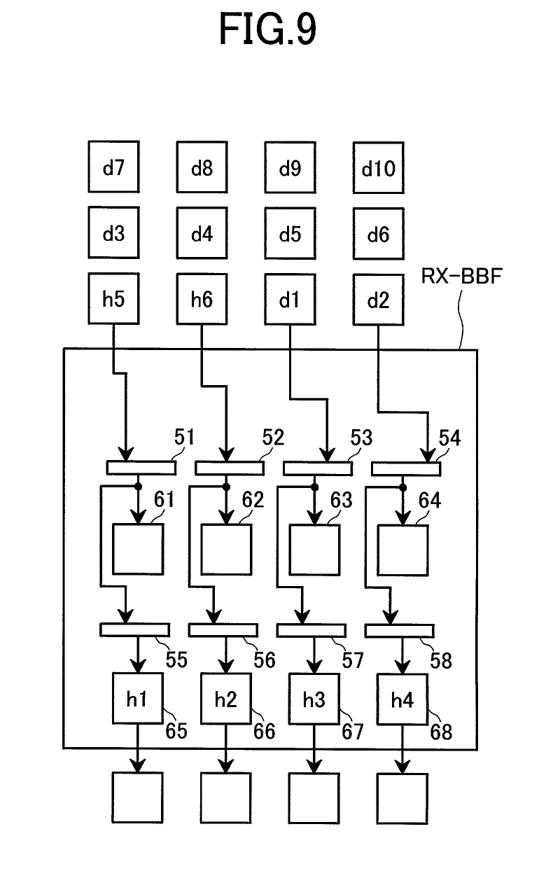

Now referring to FIGS. 9 to 12, there is shown a schematic block diagram of selected status of the selectors when receiving a frame of 6 bytes in header length, 10 bytes in data length into the boundary buffering circuit BBF as shown in FIG. 5. h1 to h6 are header signals and d1 to d10 are signals of data parts. The input from the receiving FIFO area RXFIFO will be switched by selectors so as not to introduce any inconsistency of alignment in the boundary buffering circuit to output to the main memory MAINMEM area.

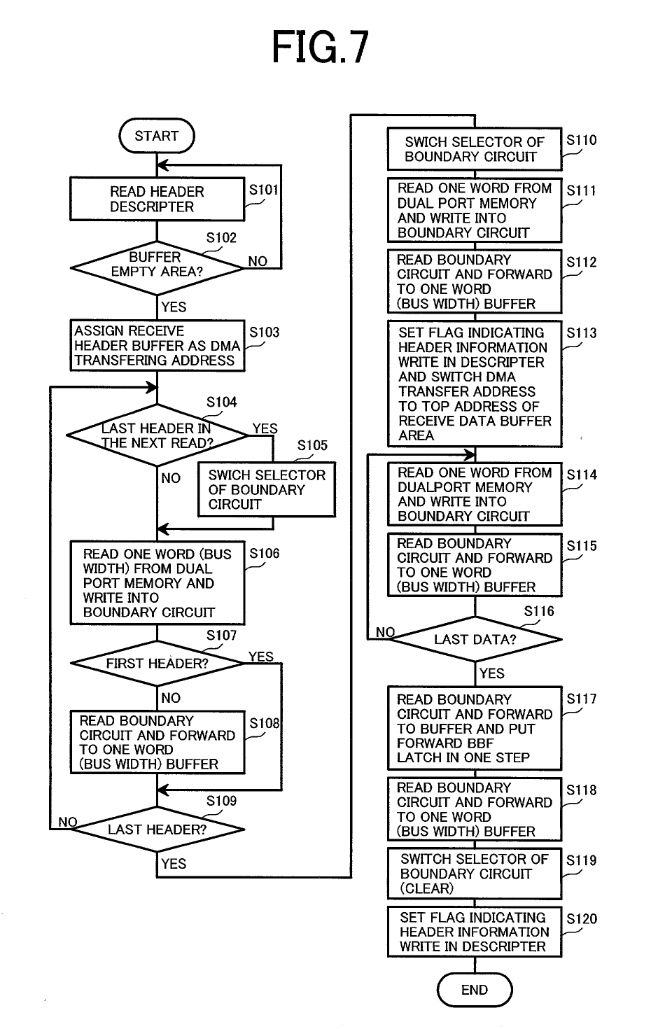

Referring to FIG. 7, there is shown a flow chart indicative of the operation of selectors in the DMA controller when receiving a frame in an RG configuration as shown in FIG. 1. The operation will be described in greater details herein below with reference to representative selector configurations shown in FIGS. 9 to 12 and a flow chart in FIG. 7, where the received frame has its header length of 6 bytes from h1 to h6, and its data part of length 10 bytes from d1 to d10.

When the target frame to be received is in the FIFO, the DMAC will start up. The selectors in the boundary buffering circuit at the time when the DMAC starts up has no data swap in the buffer, as shown in FIG. 9, will latch once in the output stage so as to output DOUTs in the immediately succeeding cycle.

In process step 101, receiving buffer descriptor RX_DCTR will be retrieved from the storage area. In process step 102 the free space in the receiving buffer RX_BUF will be checked out. In process step 102 if there is no room sufficient in the buffer then the process will go back to the preceding process step 101 to wait for the buffer to be cleared. If on contrary there is a room sufficient in the buffer then the process will proceed to process step 103, where the address of the receiving header buffer that is pointed to by the receiving buffer descriptor RX_DCTR having retrieved in process step 101 will be set to the DMA destination address.

In process step 104, current header will be examined whether to contain the last segment. The header length of the frame shown in the first preferred embodiment of the present invention is 4n+2(n=1), and the leading segment of the header is h1 to h4, so that the process will proceed to process step 106. In process step 106, the leading segment h1 to h4 of the received frame will be retrieved from the receiving FIFO area RXFIFO in the dual port memory DPMEM so as to write down in the boundary buffer circuit RX_BBF and will be latched in the output stage as is shown in FIG. 9, without any manipulation.

In process step 107, current header will be examined whether to contain the leading segment or not. If it is the leading segment then the process will branch to process step 109, if it is not then the process will proceed to process step 108, where the output DOUT1 to DOUT4 of the boundary buffer circuit RX_BBF as have been described with reference to FIG. 5 will be transferred to the receiving buffer RX_BUF.

In process step 109, current header will be examined whether to contain the last segment or not. In case of header length 4n+2 (n=1), there are still d5 and d6 in the receiving FIFO area RXFIFO, then the process will return to process step 104. In process step 104, current header will be examined whether to contain the last header segment read out. Since the last segment will be retrieved in the next reading cycle, the process will branch to process step 105.

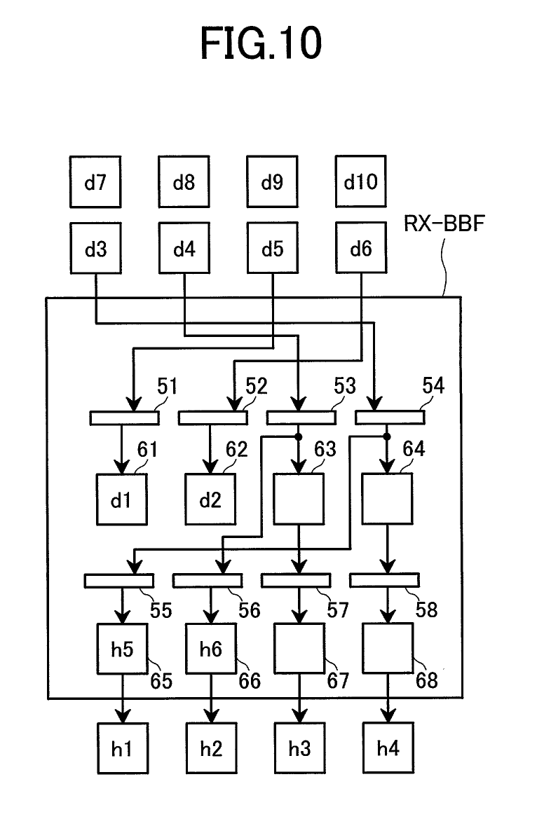

In process step 105, the selectors in the boundary buffering circuit will be switched. In case of header length 4n+2 such as the first preferred embodiment of the present invention, the selectors will be set to the configuration as shown in FIG. 10. Then, in process step 106, the last segment of the header part, h5 and h6, and the leading segment of the data part, d1 and d2 will be read out from the receiving FIFO area RXFIFO. The data will be input to the latches as shown in FIG. 10. Thereafter in process step 107 current header will be examined. However since the retrieved segment is not the leading segment, the process will proceed to process step 108.

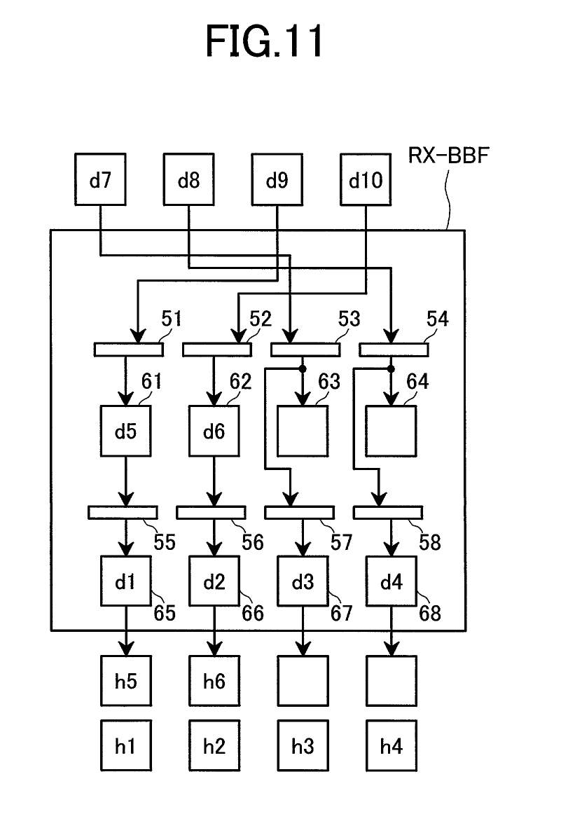

In process step 108, the contents of output stage latches, DOUT1 to DOUT4 will be DMA transferred to the receiving buffer RX_BUF. In process step 109, current header will be examined whether to contain the last segment or not. Since the last segment of header, h6, has been retrieved, the process will proceed to process step 110. In process step 110 the selectors of boundary buffer circuit RX_BBF will be switched. In case of processing header length 4n+2, the selectors will be switched as shown in FIG. 11. In this selector status the last segments of header, h5 and h6 will be transferred in the next DMA transfer cycle, and data segments d1 to d4 will be put into the last stage latches 65 to 68.

In process step 111, data segment d3 to d6 (see FIG. 10) will be retrieved from the receiving FIFO area RXFIFO into the boundary buffer circuit RX_BBF, and in process step 112, the last header segments h5 and h6 will be output to the receiving buffer RX_BUF to write it thereto. In process step 113 the destination address of DMA transfer will be changed to the start address of the receiving data buffer RXDT_BUF pointed to by the receiving buffer descriptor RX_DCTR.

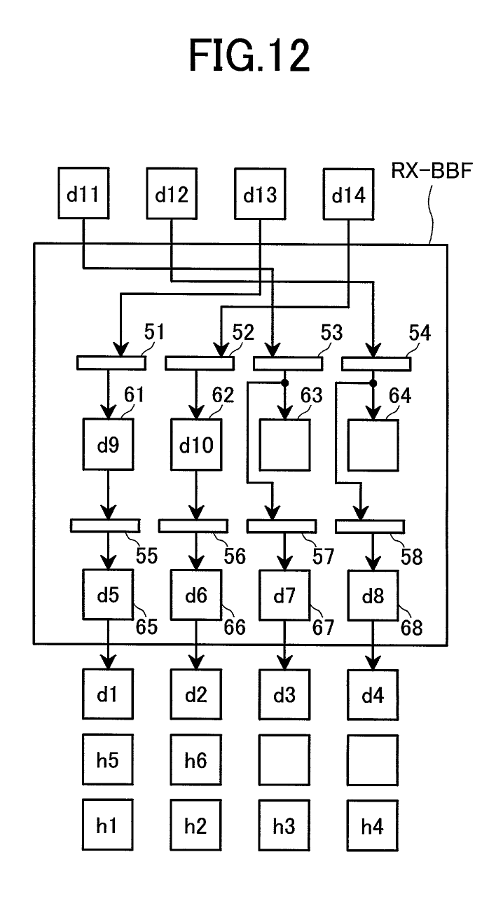

In process step 114, data segments d7 to d10 (see FIG. 11) will be retrieved from the receiving FIFO area RXFIFO into the boundary buffer circuit RX_BBF. In process step 115 data segments d1 to d4 will be DMA transferred to the receiving data buffer RXDT_BUF. In process step 116 current loaded data segments will be examined whether to contain the last segment or not. If the last segment is not yet read out then the process step will go back to process step 114. In the first preferred embodiment of the present invention, as the last data segment has been read out, the process will proceed to process step 117, where the data segments d5 to d8 (see FIG. 12), present in the last stage latches will be DMA transferred from within the boundary buffer circuit RX_BBF to step forward the latches. In process step 118, the last data segments, d9 and d10 (see FIG. 12), will be DMA transferred.

In process step 119, the selectors in the boundary buffer circuit RX_BBF will be reconfigured to default as shown in FIG. 9. Finally, in process step 120, transferred size of data and flag indicative of DMA transfer complete will be put into the receiving buffer descriptor RX_DCTR to terminate the reception process.

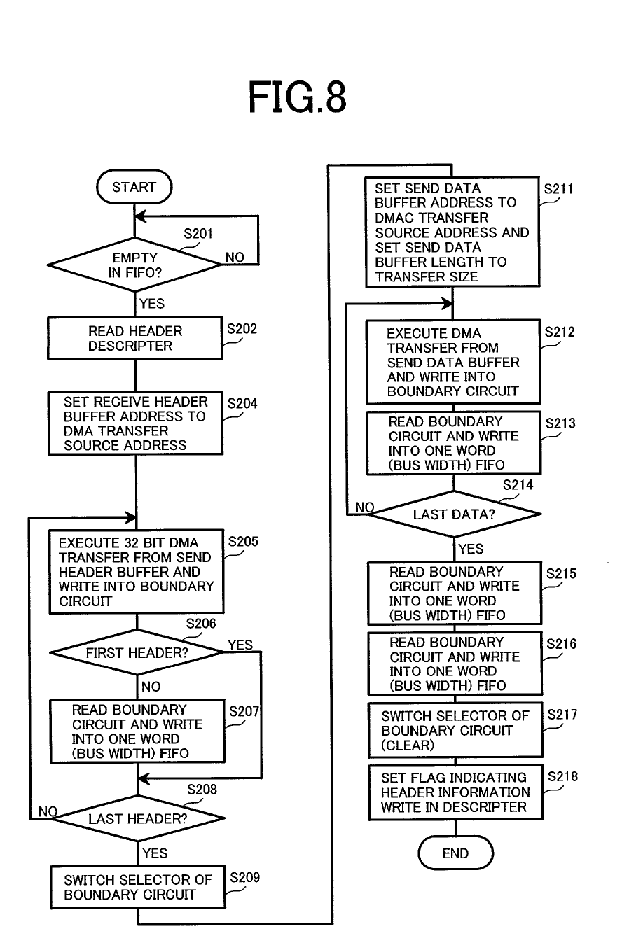

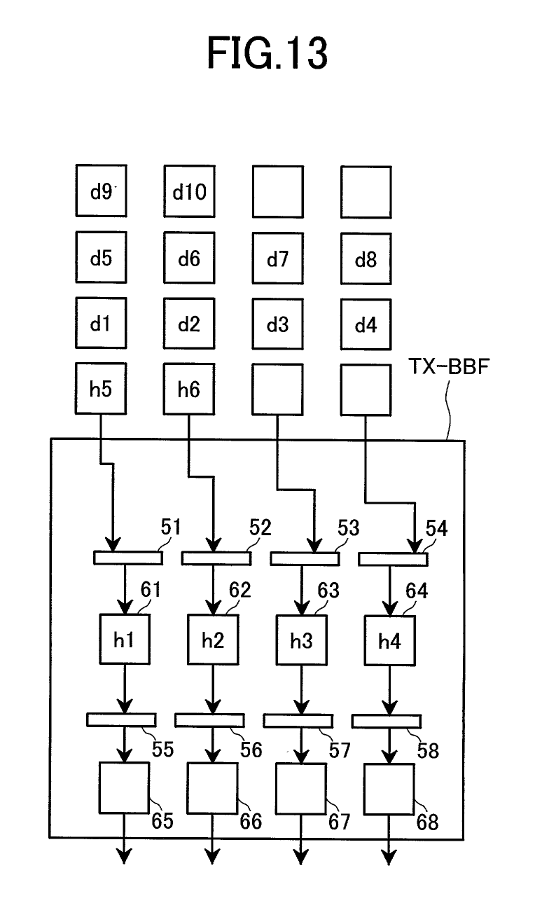

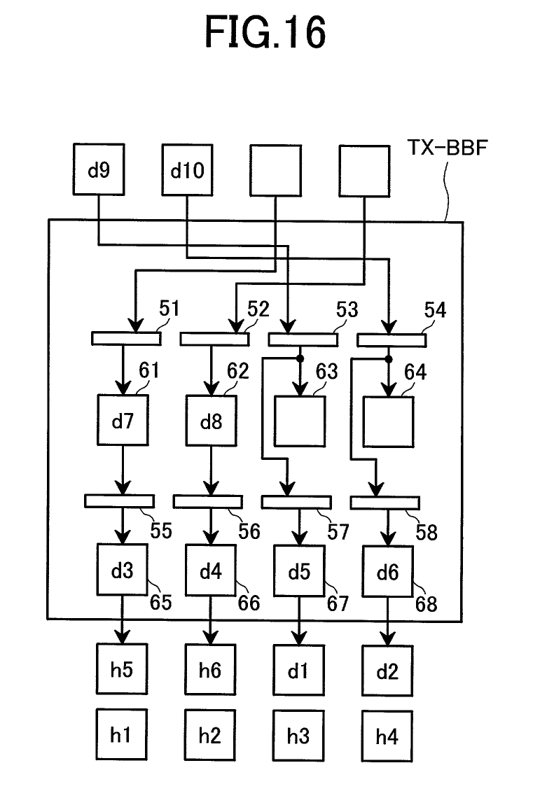

Next, the operation of frame transmission will be described in greater details with reference to FIGS. 13 to 16 indicative of selector configuration of the transmitting boundary buffer circuit TX_BBF and the flow chart (FIG. 8) indicative of transmission process. In the transmission process, as the preparation, the elements of transmission frame, namely transmission header segments h1 to h6, and transmission data segments d1 to d10 will be written into the transmitting header buffer TXHD_BUF and transmitting data buffer TXDT_BUF, respectively, by the CPU, while at the same time the data size will be written into the transmitting buffer descriptor TX_DCTR corresponding to the buffers in order to start up DMAC.

In process step 201, free available space will be checked out in the FIFO to write a frame thereto. If there is enough space then the process will proceed to process step 202. In process step 202 the DMAC will read out the transmitting buffer descriptor TX_DCTR to get the address of the transmitting header buffer TXHD_BUF and the size of header, and the address of the transmitting data buffer TXDT_BUF and the size of data. In process step 204 the start address of the transmission header buffer will be set into the source address of DMA transfer.

In process step 205, header segments h1 to h4 (see FIG. 13) will be retrieved from the transmitting header buffer TXHD_BUF and will be written into the transmitting boundary buffer circuit TX_BBF. In process step 206 current header segments will be examined whether to contain the starting segments or the next. Since the starting header segments h1 to h4 have been retrieved, the process will proceed to process step 208. In process step 208 current segments will be examined whether to contain the last segment or not. Since the current segments does not contain the last segment, the process will return to process step 205.

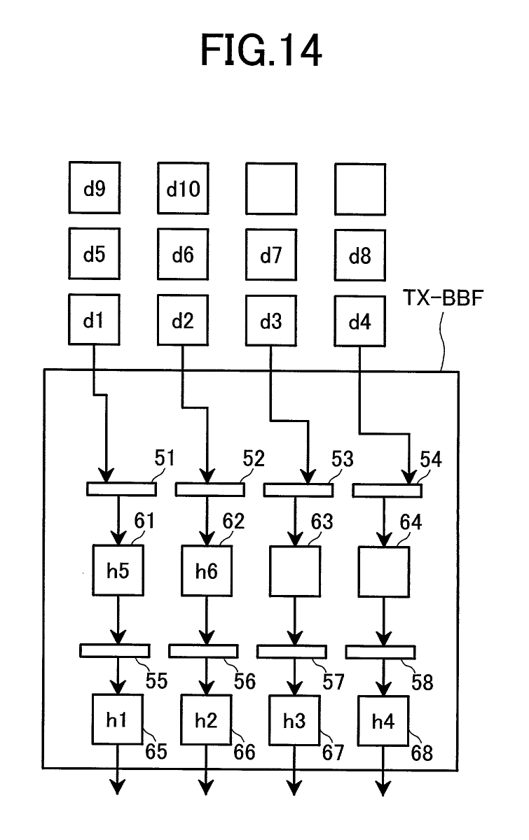

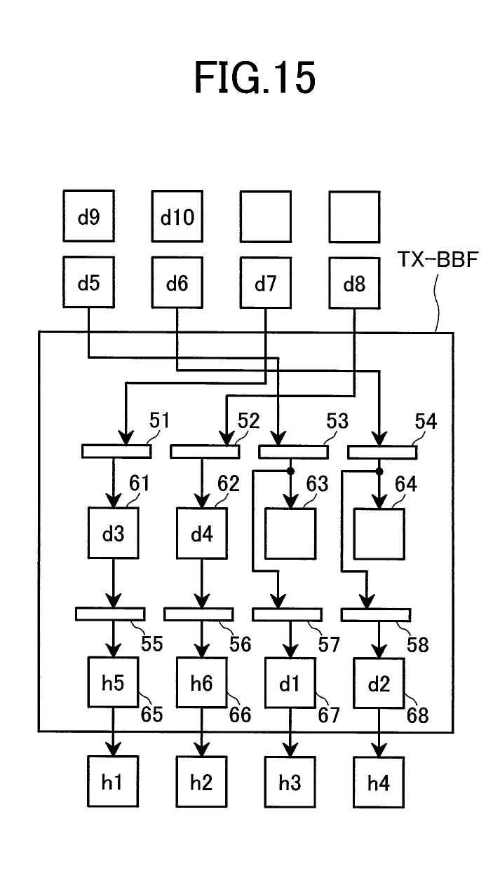

In process step 205, next header segments, h5 and h6, will be retrieved (see FIG. 14). The most significant 16 bits at this point are padded with null data. Thereafter, in process step 206, another examination will be performed and the process will proceed to process step 207. In process step 207, the header segments retrieved will be written into the FIFO, and in process step 208 current header segments will be examined whether to contain the last segment. Since the last segment has been loaded, the process step will proceed to process step 209. In process step 209, the selectors will be reconfigured to the matrix as shown in FIG. 15.

In process step 211, the address of the transmitting data buffer TXDT_BUF will be set to the starting address of DMA transfer, and the data length of the transmission data buffer will be set to the transfer size. In process step 212, DMA transfer will be performed from the transmission data buffer to write to the transmitting boundary buffer circuit TX_BBF. In process step 213 the output signals DOUT1 to DOUT4 of the transmitting boundary buffer circuit TX_BBF will be written into the transmitting FIFO area TXFIFO.

In process step 214 an examination will be performed whether the last data segment has been transferred or not. If there is still another data segment to be transferred, the process will go back to process step 212 to redo process steps 212 to 214. If the last data segment (in the first preferred embodiment, segments d9 to d10 shown in FIG. 12) has been already read out, then the process will proceed to process step 215.

In process steps 215 and 216, the data segments remaining in the transmitting boundary buffer circuit TX_BBF will be written into the transmitting FIFO area TXFIFO. In the first preferred embodiment of the present invention, at this point, data segments d5 to d10 are still remaining in the buffer (boundary buffer circuit RX_BBF) (see FIG. 12).

In process step 217, the selectors of the transmitting boundary buffer circuit TX_BBF will be reconfigured to the default selector configuration as shown in FIG. 13. In process step 218, finally, DMAC transfer completed will be flagged in the transmission descriptor to terminate the transmission process.

In the first preferred embodiment of the present invention, although free area in the FIFO is checked for the first time only, the free FIFO space examination may be alternatively performed immediately prior to each DMA transfer.

As can be appreciated from the foregoing description, boundary buffers may be used in the DMA transfer to switch selectors to achieve DMA transfer at the maximum width of bus in the transmission and reception process.

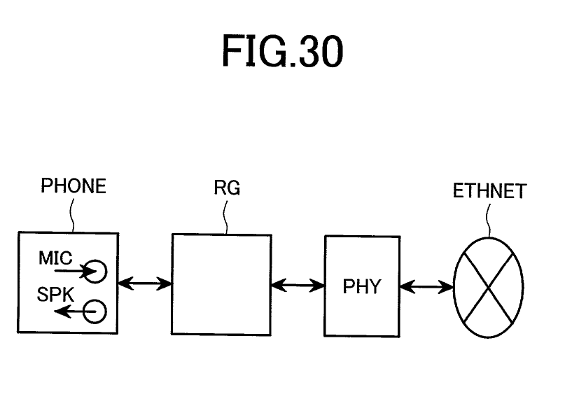

Now referring to FIG. 30, there is shown a device embodying an Internet phone called as VOIP (voice over IP), by adding a voice i/o device ‘PHONE’ including a microphone (MIC) and a speaker (SPK) to the communication controller RG of the first preferred embodiment of the present invention, and by adding a physical layer chip for the Ethernet (PHY) to the RG to connect to the Internet through an Ethernet network ETHNET. The system configured as shown in FIG. 30 may enable a desired communication, by connecting to a communication network such as the Internet through the i/o interface and communication device the voice data being transmitted and received. The header and data parts of each of transmitting and receiving frames, as have been described above, may contain some data contents which are different for each of the transmitting and receiving frames in the usual situation and may contain sometimes identical contents.

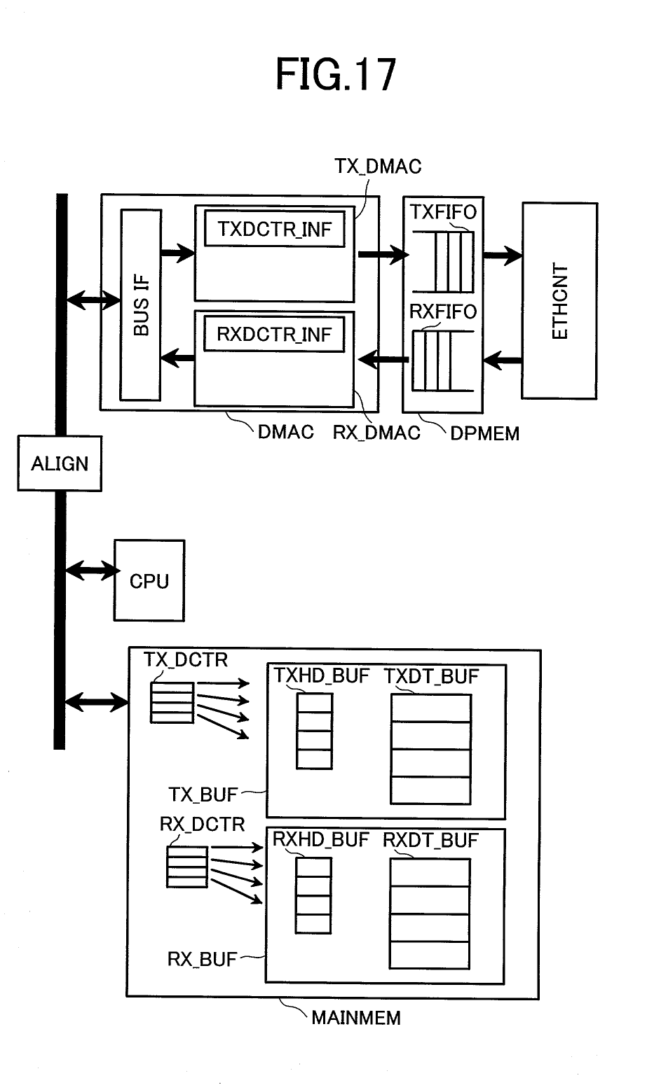

Now second preferred embodiment in accordance with the present invention will be described in greater details below. In the second preferred embodiment of the present invention, as shown in FIG. 17, an aligner ALIGN is interposed between the bus connecting to the peripheral circuits such as DMAC and the CPU bus CPUBUS connecting to the CPU and main memory MAINMEM, instead of boundary buffering circuit BBF in accordance with the preceding first preferred embodiment of the present invention shown in FIG. 1.

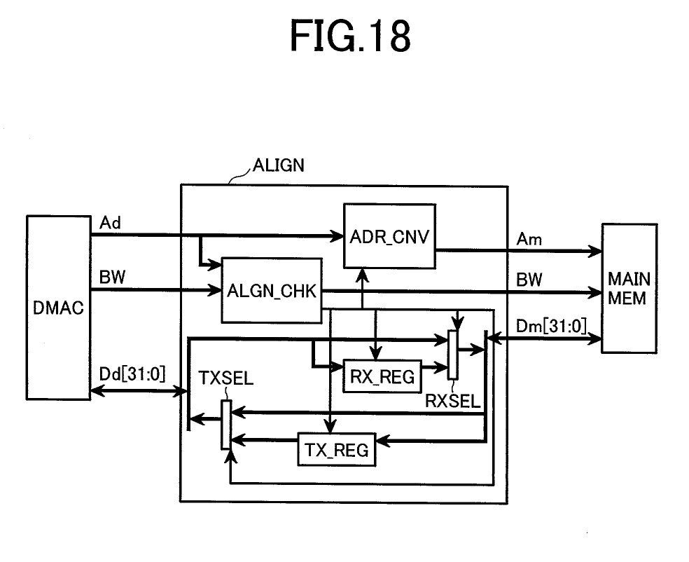

Details of the aligner ALIGN is shown in FIG. 18. The aligner ALIGN is comprised of a check circuit or unit for detecting any inconsistent alignments ALGN_CHK, an address generator circuit or unit ADR_CNV for converting an address Ad indicated by the DMAC into an address Am to output to the CPU bus CPUBUS, a latch register RX_REG for storing output data Dd from the DMAC, a receiving selector RXSEL acting as a shift register, a latch TX_REG for storing data from the storage area, and a transmitting selector TXSEL acting as a shift register. The aligner may be used not only for the DMA transfer but also the data transfer performed by the CPU.

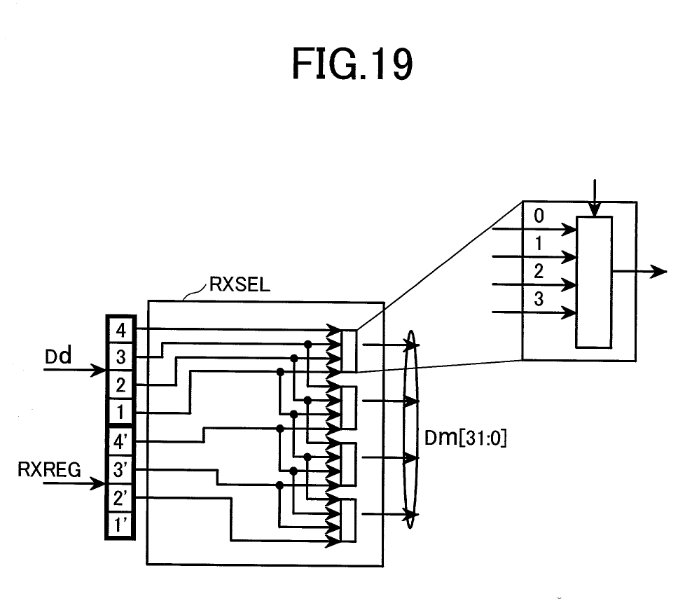

The correspondence between the selector configuration, the data on the data bus, and the order of signals in the receiving frame is shown in FIG. 19. The byte array of lesser numbers at bottom comes the top of the receiving frame. Reference numeral 1′ to 4′ are values read in the immediately preceding cycle.

The inconsistency of alignment can be detected by examining if two least significant bits of the address is not ‘0’ (or ‘00’) at the time of transfer with the data width of 32-bit. In addition the amount of shifting the shift register RXSEL will be at the value of two least significant bits of the address.

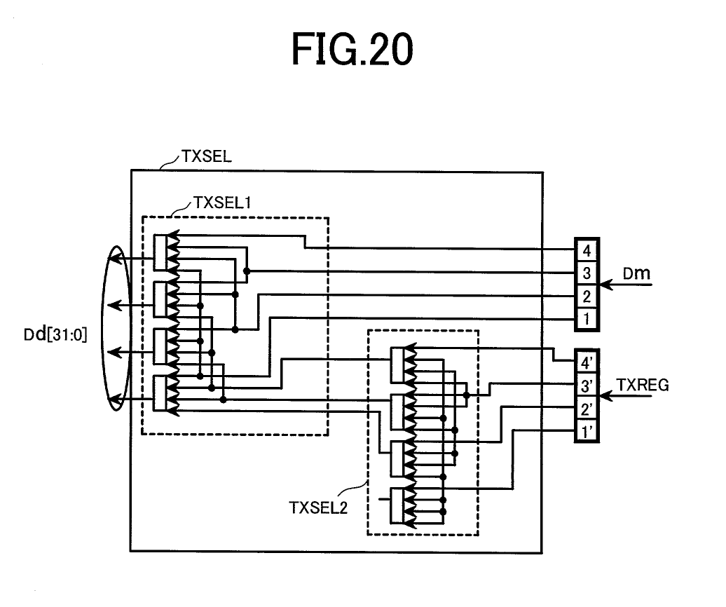

FIG. 19 is also a representative example of the RXSEL selector enlarged. The selection of selectors may match with two least significant address bits. An enlarged schematic block diagram of a representative example of the above mentioned transmitting selector Transmitting Selector TXSEL is shown in FIG. 20. The selector TXSEL is formed of TXSEL1 and TXSEL2, the selection of selectors in TXSEL1 will match with two least significant address bits. The selectors in TXSEL2 are usually set to 0, and will be set to two least significant address bits only when those two least significant address bits changes values from ‘0’ to any other value than ‘0’ for example ‘01’, ‘10’, ‘11’.

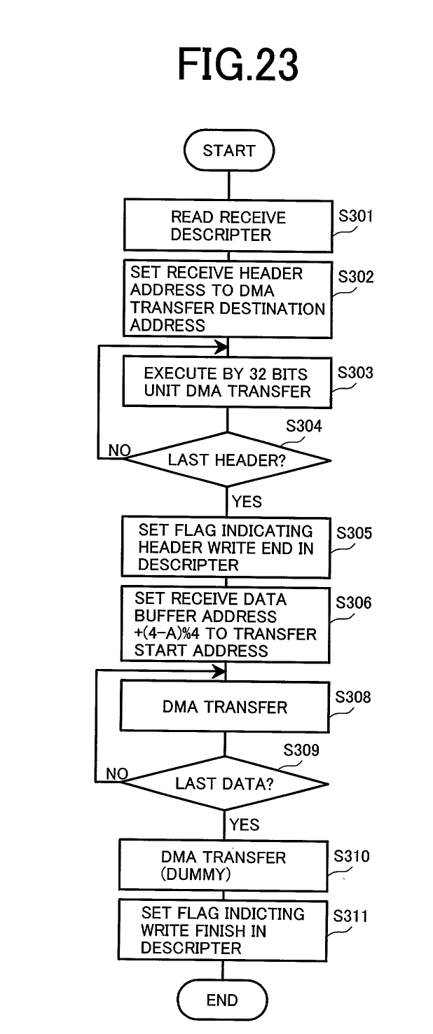

Referring to FIG. 23, there is shown a flow chart indicative of the operation of DMAC upon reception of a frame in accordance with the second preferred embodiment of the present invention shown in FIG. 17. The receiving operation will be described in greater details below with reference to FIG. 23. When started up, in process step 301, DMAC will retrieve the receiving descriptor RX_DCTR to obtain the address and size of the receiving header buffer RXHD_BUF and receiving data buffer RXDT_BUF. In process step 302 destination address of the DMA transfer will be set to the starting address of the receiving header buffer.

In process step 303, a frame will be read out from within the receiving FIFO area RXFIFO to perform a DMA transfer at the maximum bus width (32-bit width in the current embodiment). In process step 304 the last header segment is examined whether to be DMA transferred or not, and if there remains still a segment the process will go back to the process step 303 to iteratively repeat DMA transfer until the last header segment will have been sent.

During the DMA transfer at that time no inconsistent alignment will occur so that the detector in the aligner ALIGN will not detect an inconsistency and the address Ad of the DMA bus (the address supplied from the DMAC) will be passed to output to the address Am of the CPU bus (address with alignment adjusted). For the data Dd of the DMA bus, the selectors in the receiving selector RXSEL will select the number 0 signal line to put directly the data Dd into the data Dm of the CPU bus.

When the last header segment has been DMA transferred, in process step 305 a flag indicative of completion of writing a header is flagged in the receiving buffer descriptor RX_DCTR. In process step 306 in case of header length of 4n+a, for the destination address of DMA transfer, an address is set with the modulo of (4-a) % 4 added to the starting address of the data buffer area. If the header length is 6 and the starting address of the data buffer is 0×3000, then the address 0×3002 will be set.

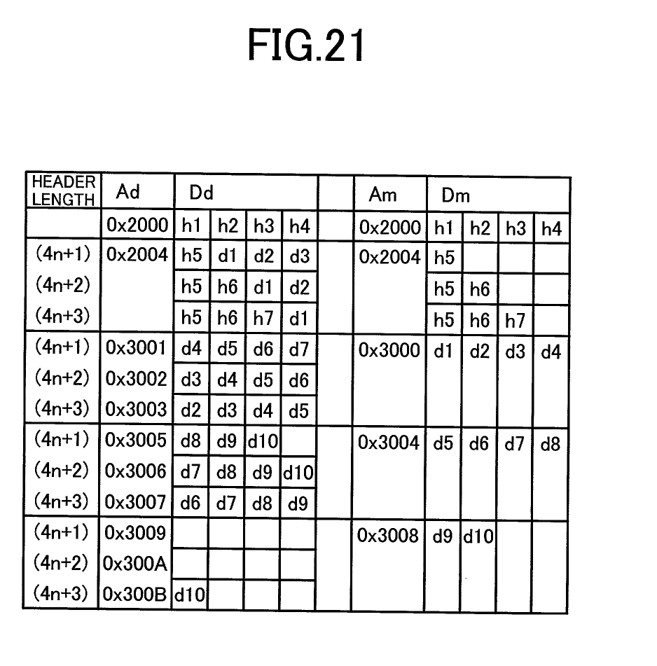

In process step 308 DMA transfer will be performed with respect to the data part. In this step, if the header length is (4n+2) as shown in FIG. 21 for example, the data lines Dd (i.e., h5, h6, d1, d2) of the address Ad (0×2004) passed through the aligner ALIGN in the immediately previous process cycle will be latched in the latch register RX_REG. These data Dd will be input to the receiving selector RXSEL along with the data lines Dd (d3, d4, d5, d6) newly supplied. With the address Ad being 0×3002, when selecting the signal lines of the value indicated by the inconsistent alignment detector circuit ALGN_CHK (two least significant address bits=2, or ‘10’), on the data lines Dd of the bus to which the DMAC is connected the above data d1, d2 are added to the data d3 and d4 to obtain DM=d1, d2, d3, and d4. The address generator circuit ADR_CNV will mask two least significant address bits Ad to output 0×3000 as Am.

In other words, the address generator will generate the address (or, first address) having adjusted in order to output to a processor such as a CPU based on the address supplied or output from the DMA controller that controls access to the memory. In this context Dm (or, first data) is the data corresponding to thus adjusted address, and if there occurs an inconsistency of alignment, the leading data of the address Ad output, which causes the inconsistency of alignment, will be split and stored in the aligner as a part of the first data Dm.

If the Ad output from the DMAC is 0×3006, and Dd=d7, d8, d9, d10, then data d5 and d6 from within the data lines Dd (d3, d4, d5, d6) of the address A=0×3002, will be added to d7 and d8 to obtain Am=0×3004, Dm=d5, d6, d7, d8.

In process step 309, current data segment will be examined to see whether the last segment of data part has been transferred or not, and if there remains still a data segment the process step will return to the process step 308 to proceed DMA transfer of the remaining data. If the transfer has been completed then the process will proceed to process step 310.

In other words, the process step 308 as have been described above may be described as temporarily storing the trailing half of data segment (d5 and d6) that can be yield by splitting output data Dd of the DMA controller into the aligner buffer, connecting the leading half of data segment (d7 and d8) contained within the DMA transferred output data of the immediately following cycle with the above mentioned trailing half of data segment to transfer at the maximum bus width, and temporarily storing in the aligner the trailing half of data segment (d9 and d10) of the DMA transferred output data, which has to be transferred in the next cycle.

In process step 310, DMA transfer is performed by using dummy data at the end of a frame to output all buffered data remaining in the latches of the aligner. At last, in process step 311 the receiving data size will be written into the receiving buffer descriptor RX_DCTR and a flag indicative of receiving complete of the data part will be set to terminate the operation.

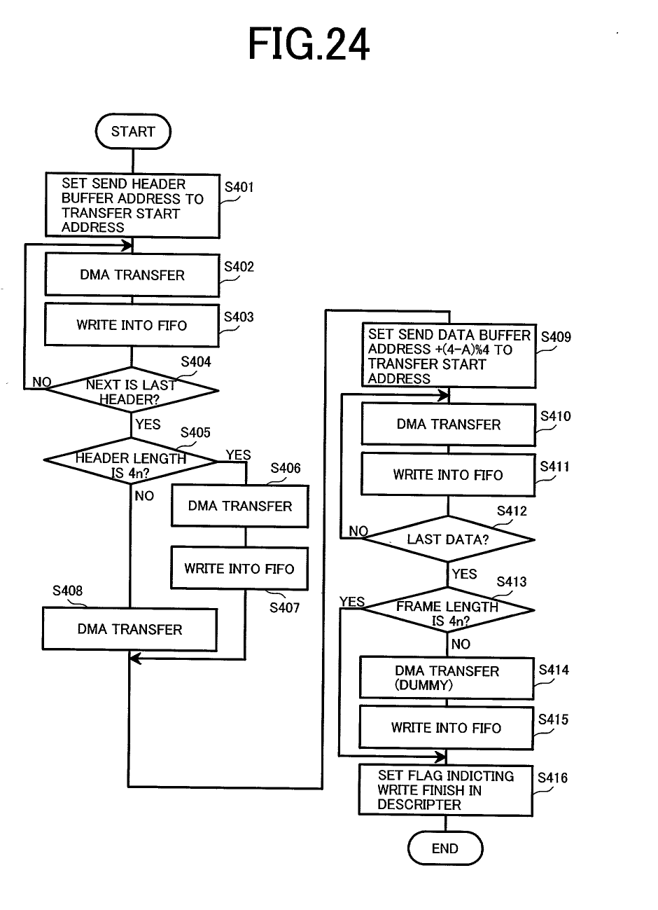

Referring to FIG. 24, there is shown a flow chart depicting the transmitting operation of DMAC. The transmitting operation of the aligner will be described in greater details below with reference to FIG. 18. Prior to the start-up of the DMAC, the CPU will write the header and data parts of the frame being transmitted into the transmitting header buffer TXHD_BUF and transmitting data buffer TXDT_BUF, respectively, write the data size into the transmitting buffer descriptor TX_DCTR, and will set the flag indicative of the presence of transmission data available. Thereafter the CPU will interrupt the DMAC to start.

The DMAC, when called, will read the descriptor in process step 401 to set the address of the transmitting header buffer TXHD_BUF written in the transmitting buffer descriptor TX_DCTR into the source address of DMA transfer. In process step 402, the DMAC will execute the 32-bit DMA transfer. In this step since there will not occur an inconsistency of alignment between the address and data passing through the aligner, the address and data will be output without conversion. The value of Dd will be the value of data lines Dm on the CPU bus, and the value of Ad will be the value of address lines Am on the CPU bus.

In process step 403 data on the data bus Dd on the bus to the DMAC will be written into the transmitting FIFO area TXFIFO. In the next process step 404, data to be read in the immediately following cycle will be examined whether to be the last header segment. If the next segment is not the last header segment, then the process step will go back to the process step 402 to iteratively repeat the process steps 402 to 404 until the second last data of the header. If the next data to be retrieved is the last header segment, then the process step will proceed to process step 405. In process step 405, the header length will be examined whether to be a multiple of 4 (4n). If the header length is a multiple of 4, then in process step 406 the data containing the last header segment will be DMA transferred, and in process step 407 the data will be written into the FIFO.

If the data length is not a multiple of 4, then the data will be DMA transferred in process step 408 although the data will not be written into the transmitting FIFO area TXFIFO (or the FIFO address shift will be stopped). The reason is that the data to be written into the transmitting FIFO area TXFIFO needs to be written as 32-bit data that the end of header and the beginning of data are consecutive.

In process step 409 that follows, the source address of DMA transfer will be set to the address of the starting address of the transmitting data buffer TXDT_BUF added with the modulo of (4−a) % 4 when header length is in the form of 4n+a. In the present embodiment since the header length is 6, the modulo there of is then 2, and the source address of DMA transfer will be set to 0×3002 if the starting address of the data buffer is 0×3000.

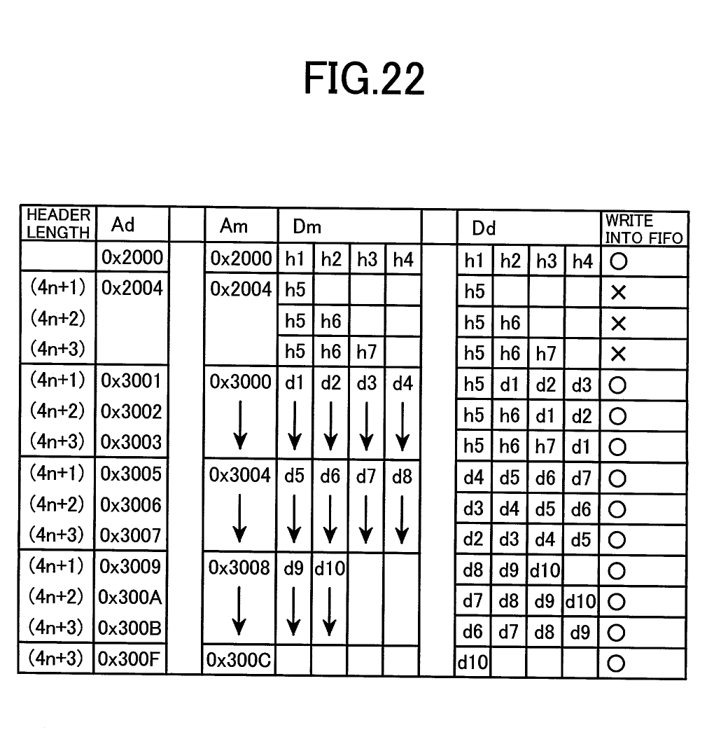

In process step 410, the data part will be read out, and in process step 411 the data will be written into the FIFO. The operation of the aligner will be described in process step 410. As shown in FIG. 22, the aligner ALIGN when receiving 0×3002 for the address Ad, will detect the inconsistency of the address alignment. Two least significant address bits are 2 so that the selectors in the selector TXSEL will select the signal lines of 2 (the selectors TXSEL2 will usually select signal lines of 0, except for the first cycle of thus occurred inconsistency of alignment where two least significant bits will be changed from 0 to any other values, and where TXSEL2 will select the same lines as TXSEL1)

For example, when the header length is 4n+2, header segments h5 and h6 of Am=0×2004 which have been latched in the TX_REG in the immediately preceding cycle and the starting data segments d1 and d2 of the data part of Am=0×3000 will be selected and connected to output h5, h6, d1, d2 into Dd.

In addition, when Am generated by the address generator circuit ADR_CNV is 0×3004 and Dm=d5, d6, d7, d8, then data d3 and d4 from within the data lines Dm (d1, d2, d3, d4) of the address Am (0×3000) will be connected with d5 and d6 to form Dd=d3, d4, d5, d6.

In process step 412 loaded data will be examined whether or not data has been read to the end. If there remains data segment, then the process steps 410 to 412 will be again processed. If all data has been read, the process will proceed to process step 413. The above process steps 410 to 412 may allow consecutive DMA transfer as similar to the process step 308 for executing DMA transfer of data part.

In process step 413 frame length will be examined whether or not the length is a multiple of 4. If the frame length is not a multiple of 4, indicating that the tail of data part not written into the transmitting FIFO area TXFIFO still remains in the TX_REG, then data will be DMA transferred again (process step 414) to retrieve the remaining data to the end so as to write into the transmitting FIFO area TXFIFO (process step 415). If the frame length is 16, more specifically header length is 6 and data length is 10, and the frame length is a multiple of 4 in such a case as the present embodiment, the process will proceed to process step 416. In process step 416, finally, the transmission complete flag of the buffer will be set in the transmitting buffer descriptor TX_DCTR and the process will terminate. Data transfer at the maximum bus width in addition to the DMA transfer may be enabled between a memory such as FIFO and the storage area by the aligner if there is an inconsistent alignment during data transfer.

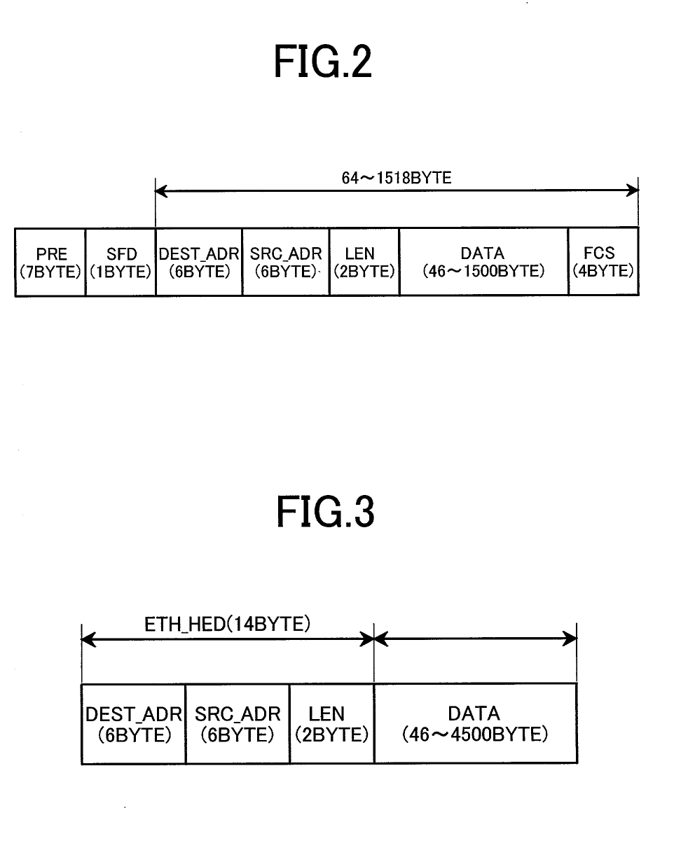

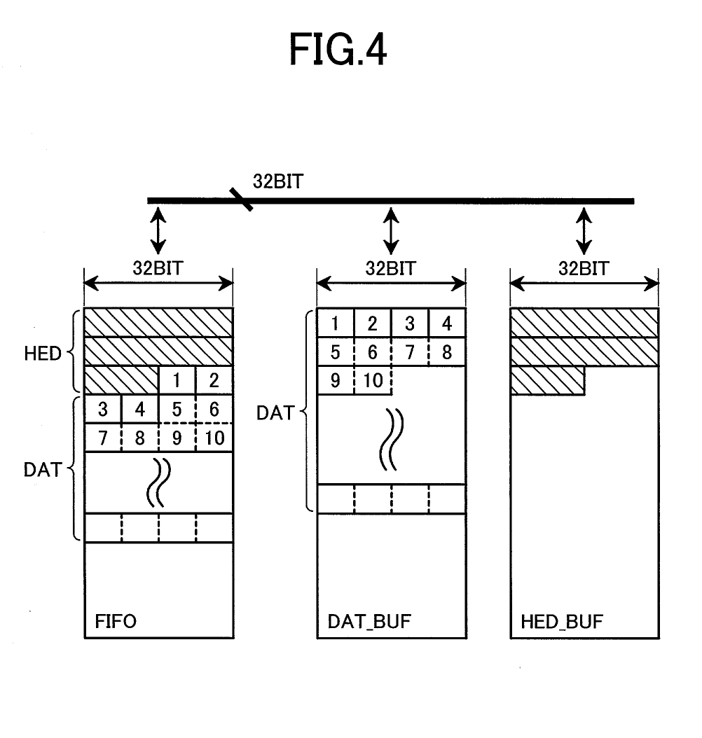

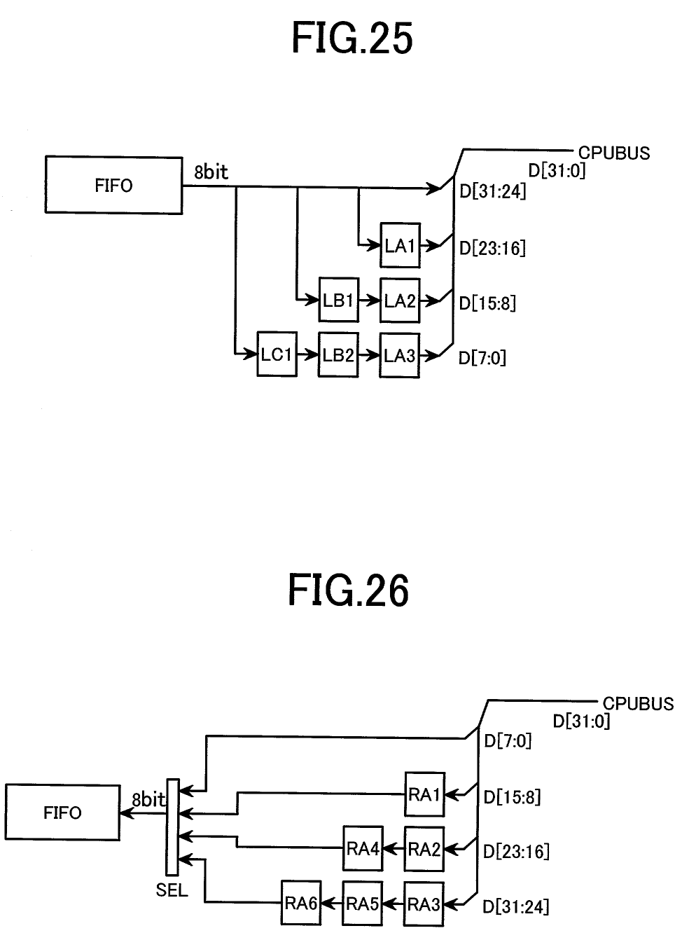

Although the first embodiment as have been described above with reference to FIGS. 1 to 16 and FIG. 30, and the second embodiment as have been described above with reference to FIGS. 17 to 24 have been described by way of example with the bus width of the system comprised of FIFO and CPU being identical width, the present invention may not be limited thereto. The present invention may be embodied in other specific forms without departing from the spirit or essential characteristics thereof. For instance, referring to FIG. 25, where there is shown a configuration with which a received frame may be transferred at the maximum bus width if the bus width of FIFO is narrower than the system bus width. As shown in FIG. 25, this configuration includes latches LA1, LB1, LC1 for storing 8-bit data retrieved from the FIFO during transfer, a latch LA2 for latching the output from the LB1, a latch LB2 for latching the output from the LC1, and a latch LA3 for latching the output from the latch LB2. Combining FIFO output with the output from the latches LA1, LA2, LA3 is to form 32-bit data by reading data consecutively four times.

Another configuration is shown in FIG. 26, in which data read out in 32-bit width from the storage area may be enabled to write into the FIFO with the bus width of 8-bit. Latches RA1 to RA6 and selectors will be interposed between the 32-bit data bus and the 8-bit FIFO. In the first 32-bit reading cycle, leading 8 bits D [0:7] of the signal data will be written into the FIFO. At this point data D [8:15] will be stored in the latch RA1, data D [16:23] will be stored in the latch RA2, data D [24:31] will be stored in the latch RA3, respectively. In the following second reading cycle selectors will be switched so as to latch data from the RA2 into the RA4 to write to the FIFO, so that the data from the RA2 will be stored in the RA4 and data from the RA3 will be stored into the RA5. In the third cycle, the selectors will be again switched so as to write data in the RA4 into the FIFO, and to store data in the RA5 into the RA6. In the last cycle the selectors will be again switched to write data in the RA6 into the FIFO so as for all data read out from the main storage area in 32-bit wide to be stored in the FIFO.

More specifically, in the configurations of data transfer as shown in FIGS. 25 and 26, if the bus width of FIFO is narrower than the CPU bus width, then data transferred from the FIFO will be temporarily stored in a buffer to split to the bus width of the CPU, within the DMA controller, which controller stores data by means of data connectors (LA1 to LA3, LB1 to LB2, LC1) formed of latches for performing DMA transfer on the CPU bus and by means of data dividers (RA1 to RA6) for temporarily storing data sent at the bus width of the CPU into latches and retrieving to truncate to the bus width of FIFO in order to write into the FIFO.

Preferably, the circuits shown in FIG. 25 and FIG. 26 can operate at the speed of four times of the DMA transfer rate of the 32-bit bus. More specifically, the operating frequency of the FIFO and the data connector may be set to operate an integer multiple of the ratio of the FIFO bus width to the CPU bus width with respect to the operating frequency of the bus to which the CPU is connected so that waiting for 32-bit data during DMA transfer at the end of writing to or reading from the FIFO can be eliminated, providing an enhanced transfer rate.

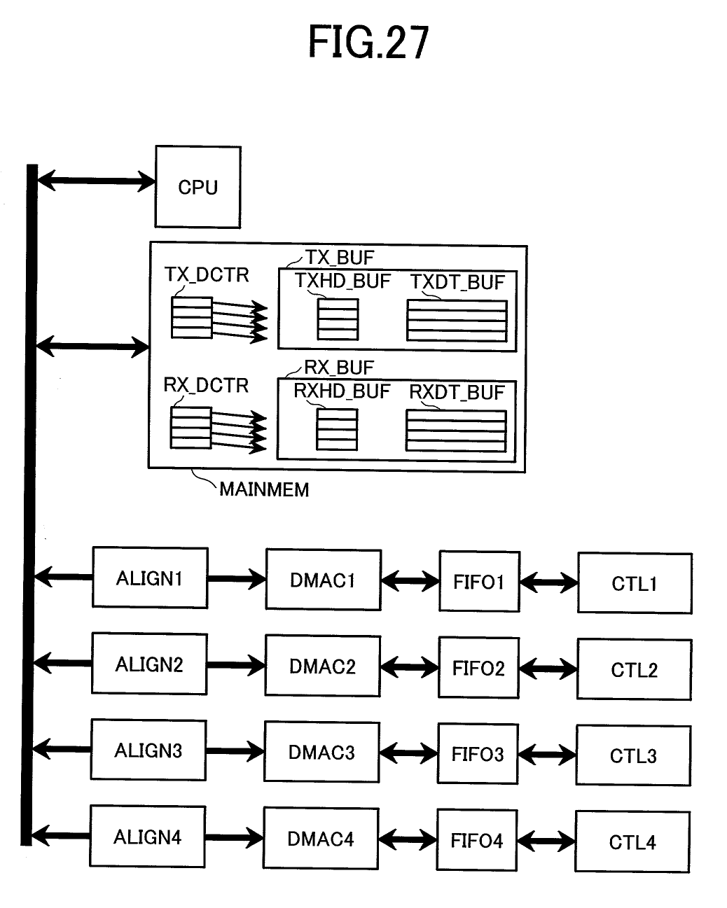

Although in the second preferred embodiment an aligner is interposed between a DMAC and the CPU bus, aligners ALIGN 1 to 4 may be provided, as shown in FIG. 27, between a plurality of communication i/o cores, CTL 1 to 4, and DMAC 1 to 4 associated therewith.

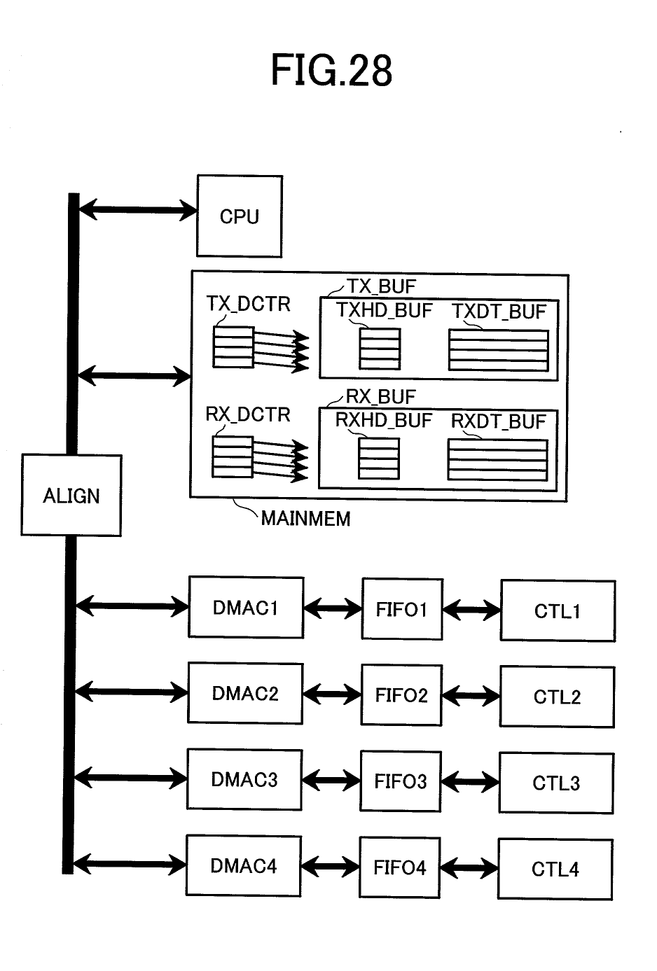

Alternatively, although in the second preferred embodiment of the present invention, an aligner is interposed between a DMAC and the CPU bus, an aligner ALIGN may be provided, as shown in FIG. 28, between the DMAC bus to which DMAC 1 to 4 associated with a plurality of communication i/o cores, CTL 1 to 4, are connected and the bus to which the main memory MAINMEM and CPU are connected. In this case latch registers TX_REG and RX_REG in the aligner as shown in FIG. 18 will be provided for every DMAC to provide a means for switching input to the selector TXSEL and RXSEL, or one aligner may serve a plurality of DMACs if a DMAC that starts DMA transferring will not release the bus priority of other DMACs until the transfer of a frame is completed.

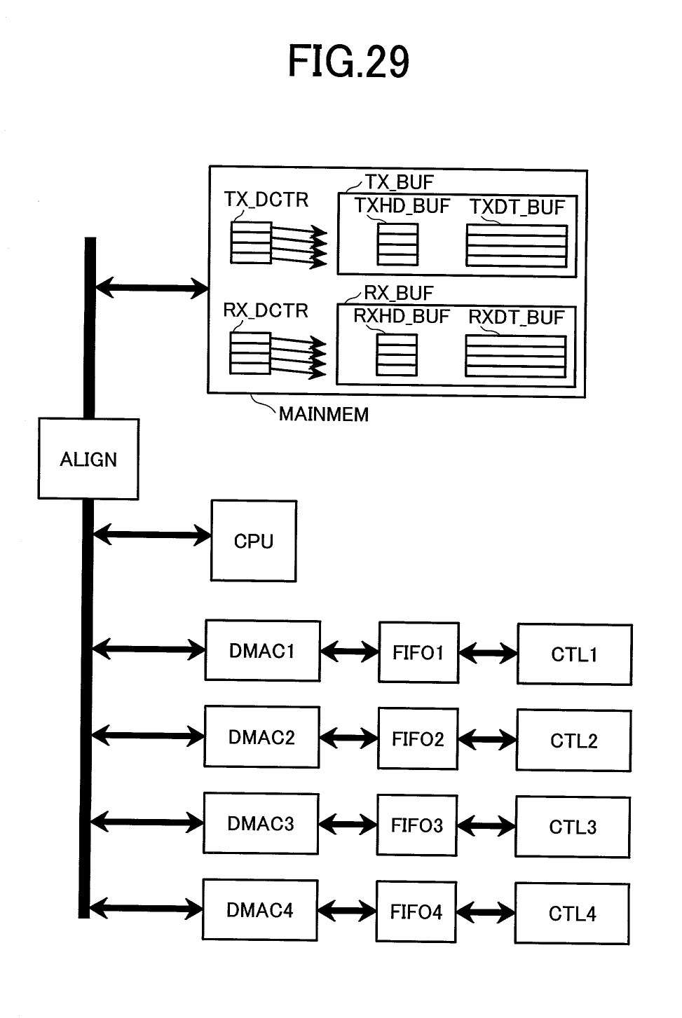

Furthermore, in the second preferred embodiment of the present invention, although an aligner may be interposed on the bus to which a DMAC and the CPU are connected, the aligner may be provided, as shown in FIG. 29, between the bus to which the CPU and a plurality of DMACs 1 to 4 are connected, and the bus to which the main memory MAINMEM is connected. In this manner, data transfer that may or may not introduce an inconsistent alignment in the transfer using CPU can be enabled at the maximum bus width. In addition, any elements except for the storage area as have been described above, such as the CPU, DMA controller, memory, may be incorporated in a one-chip microcomputer.

In accordance with the present invention, data transfer at the maximum bus width at the time when an inconsistency of alignment is present will be enabled and DMA transfer of higher rate will be achieved by providing a circuit configuration for solving the inconsistent alignment.

What is claimed is:

1. Data transfer equipment, comprising:
a CPU for data communication controller;
a storage area for storing a communication frame transmitted and received through a bus to which said CPU is connected;
a controller for controlling the transfer of said communication frame without intervention of said CPU;
a memory provided between said controller and a communication device including physical layer and logical layer;
wherein a transmitting header memorizing area, a transmitting data memorizing area, a receiving header memorizing area, and a receiving data memorizing area are provided in said storage area in order to divide a transmitting frame into a header part and a data part thereof and divide a receiving frame into a header part and a data part thereof for storing said transmitting and receiving frame;
wherein said controller contains an alignment controller for controlling the alignment of said transmitting and receiving frames each having said header and said data parts with the addresses provided for each memorizing area in said storage areas;
wherein said controller splits said receiving frame stored temporarily in said memory into said header and said data parts thereof so as to store said header part of said receiving frame into said receiving header memorizing area and to store said data part of said receiving frame into said receiving data memorizing area, respectively, without the needs of intervention by said CPU, by means of data transfer through said alignment controller;
wherein said controller further instructs said alignment controller to transfer therethrough said header part of said transmitting frame from said transmitting header memorizing area to said memory, and thus instructs said alignment controller to transfer therethrough said data part of said transmitting frame from said transmitting data memorizing area to said memory, thereby reconstructing a transmitting frame within said memory.

2. Data transfer equipment according to claim 1,
wherein said header part and said data part of each of said transmitting and receiving frames have some data contents different for each of said transmitting and receiving frames in an usual situation and include sometimes identical data content.

3. Data transfer equipment according to claim 1,
wherein said controller is a DMA controller, and said data transfer is a DMA transfer.

4. Data transfer equipment according to claim 1,
wherein said memory is a dual port memory comprising FIFOs, and
wherein said controller includes said alignment controller, when transferring said data part of said receiving frame from said FIFO to said receiving data memorizing area or when transferring said data part of said transmitting frame from said transmitting data memorizing area to said FIFO, thereby to compensate for the inconsistency of said alignment and enable transferring said data part of said transmitting frame or said receiving frame at the maximum bus width of the system even if there occurred an inconsistency of said alignment for said data part of said transmitting frame or said receiving frame with said addresses.

5. Data transfer equipment, comprising:
a CPU for data communication controller;
a storage area for storing a communication frame transmitted and received through a bus to which said CPU is connected;
a controller for controlling the transfer of said communication frame without intervention of said CPU;
a memory disposed between said controller and a communication device including a physical layer and a logical layer; and
an aligner interposed between a bus for the connection to said storage area and a bus for the connection to said controller,
wherein said aligner comprises an address generator for generating addresses, a detector for detecting any inconsistency of alignment, a register for storing data, and a selector for selecting said stored data;
wherein said aligner is capable of detecting the inconsistency of the alignment at the detector when there is an inconsistent alignment of data transferred from said storage area with the address output from said controller and presented on the bus for the connection to said controller;
wherein said aligner is capable of dividing said data transferred to said bus and said address output into a first data corresponding to a first address consistently aligned through said selector, so as to output said first data to said bus for the connection to said storage area.

6. Data transfer equipment according to claim 3,
wherein said controller is a DMA controller.

7. Data transfer equipment according to claim 6,
wherein said memory is a dual port memory comprising FIFOs;
in case of consecutive transferring using DMA, said data transfer equipment buffer the trailing half of data part split from the output data from said DMA controller into said aligner to connect said trailing half of data part with the leading half of data part in the output data of said DMA transfer for the next transfer cycle for enabling the transfer for the maximum bus width, while buffering the trailing half of the data part of the output data for said DMA transfer to be transferred in the following cycle into said aligner.

8. Data transfer equipment according to claim 5,
wherein said first address is the address generated by said address generator based on the address output;
said first data is the data corresponding to said first address;
when there occurs the inconsistency, the leading data part in the address output that causes the inconsistency is divided and stored in said aligner as data part of said first data.

9. Data transfer equipment according to claim 6,
wherein said aligner is interposed between said DMA controller and said bus.

10. Data transfer equipment according to claim 6,
wherein said aligner is interposed between the bus for the connection to peripherals including said DMA controller and the bus provided for the connection between said CPU and said storage area.

11. Data transfer equipment according to claim 6,
wherein said aligner is interposed between the bus provided for the connection between said CPU and one or a plurality of said DMA controllers and the bus for the connection to said storage area.

12. Data transfer equipment according to claim 7,
wherein said data transfer equipment enables said aligner not only for said DMA transfer but also for the data transfer by said CPU.

13. Data transfer equipment according to claim 9,
wherein said data transfer equipment enables said aligner not only to implement the DMA transfer between said memory and said storage area but also to implement the transfer at maximum bus width in case of alignment inconsistency when the data transfer between said memory and said storage area is performed.

14. Data transfer equipment according to claim 6, further comprising:
a data connector, said connector including
a latch for buffering data transferred from said FIFO and for buffering in said DMA controller when the bus width of said FIFO is narrower than the bus width of said CPU so as for the data to fit to the bus width of said CPU and wherein said DMA controller performs said DMA transfer on the bus to said CPU;
a data divider for buffering data transferred in the bus width of said CPU by means of said latch so as to retrieve and truncate the data to the bus width of said FIFO for writing thus truncated data into said FIFO.

15. Data transfer equipment according to claim 14, in which:
said FIFO and said data connector are set to operate at the operating frequency of a multiple of the operation frequency for the bus for the connection to said CPU, at a integer ratio of the bus width of said FIFO to the bus width of said CPU.

16. Data transfer equipment according to claim 6, in which:
said CPU, DMA controller, and memory are integrated into a one-chip microcomputer.

17. Data transfer equipment according to claim 1,
wherein said data transfer equipment is capable of connecting to the communication network through an input and output interface unit of the voice data to be transmitted or received and a communication device in order to perform the desired communication.

18. An aligner, comprising:
a detector for detecting any inconsistency in the alignment that is occurred during data transfer;
an address generator for generating addresses;
a register for storing data input from any external devices; and
a selector for selecting said data stored and for processing said data;
wherein said aligner uses said detector to enable to detect said inconsistency of alignment for generating address having said alignment adjusted in said address generator and enable to compensate for the inconsistent alignment at the time said inconsistency of alignment has occurred, so as to be capable of transferring data in correspondence with said address adjusted at the maximum width of the system bus.

19. An aligner, according to claim 18,
wherein said address generator uses the address supplied from a DMA controller for controlling an access to memory so as to generate said address adjusted being output to the processor including the CPU.

20. An aligner, according to claim 19,
wherein when no inconsistency of alignment is present, said detector detects no inconsistency, hence the address supplied therefrom passes through said aligner.
